(19) United States
(12) Patent Application Publication
(10) Pub. No.: US 2015/0013169 A1
(43) Pub. Date: Jan. 15, 2015

(54) RAZOR CARTRIDGES

(71) Applicant: The Gillette Company, Boston, MA (US)

(72) Inventor: Paul Leslie Warrick, Reading (GB)

(21) Appl. No.: 14/297,728

(22) Filed: Jun. 6, 2014

(30) Foreign Application Priority Data
Jul. 10, 2013 (EP) 13175865.8
Jun. 3, 2014 (EP) 14170922.0

(51) Int. Cl. B26B 21/40; B26B 21/56; B26B 21/22

(52) U.S. Cl. CPC B26B 21/4031; B26B 21/222; B26B 21/565
USPC 30/50

(57) ABSTRACT

A razor cartridge has a housing having a front and a rear. At least two adjacent blades are provided, each pair having a leading blade and a trailing blade. Each of the leading and trailing blades having a cutting edge directed towards a front of the housing, the cutting edge of the leading blade being positioned between the cutting edge of the trailing blade and the front of the housing. A span δₛ of less than 1.0 mm is provided between the cutting edges of at least one adjacent pair of trailing and leading blades and an inter-blade gap δ_{g} is provided between said pair of adjacent leading and trailing blades, measured at the shortest distance between the adjacent leading and trailing blades, wherein the gap δ_{g} is less than or equal to the span and greater than 0.15 mm.

### FIELD OF THE INVENTION

The present invention relates to razor cartridges, specifically the arrangement of blades within a razor cartridge.

### BACKGROUND OF THE INVENTION

There are a multitude of razors and razor cartridges currently on the market that have been fine tuned over the years to ensure they provide a close and comfortable shave. More recent razor cartridges on the market have multiple blades (for example, 3, 4, 5, or 6). Increasing the number of blades tends to improve the closeness and comfort of a shave, but leads to other problems. Typically, as additional blades are provided in a cartridge, the distance between adjacent blade edges has been reduced. This reduction in span between adjacent blade edges results in a closer shave, as consecutive blades are able to cut the same hair, with a first blade pulling a hair out of the skin surface while cutting it and then a subsequent blade cutting (and pulling) the same hair before it fully retracts. The reduction in span also provides for a more comfortable shave, as there is less room between blades for skin to bulge. However, there are downsides to reducing the span between adjacent blades, in particular the reduction in space for wash-through of hair and shaving debris.

It is therefore an object of the present invention to provide a razor cartridge that is able to capitalize on the benefits of a reduced span between blades without compromising on e.g. wash-through.

### SUMMARY OF THE INVENTION

According to a first aspect, there is provided a razor cartridge comprising a housing with a front and a rear; at least two adjacent blades, each pair of adjacent blades having a leading blade and a trailing blade, the leading and trailing blade each having a cutting edge directed towards a front of the housing, the cutting edge of the leading blade being positioned between the cutting edge of the trailing blade and the front of the housing, wherein at least one pair of adjacent blades, and preferably each pair of adjacent blades, independently has
i) a span δₛ of less than 1.0 mm between the cutting edges of the adjacent trailing and leading blades, and
ii) wherein said at least one pair of adjacent blades independently has an inter-blade gap δ_{g} between the adjacent leading and trailing blades measured at the shortest distance between the leading and trailing blades, wherein the gap δ_{g} is less than or equal to the corresponding span of said pair of adjacent blades, i.e. less than 1.0 mm and is greater than 0.15 mm.

There are multiple benefits to reducing the span compared with conventional razors on the market. For example, a) the reduced span between blades takes better advantage of the hysteresis effect caused when multiple blades are able to cut the same hair, resulting in a closer shave; and b) there is less room for skin to bulge between the blades, significantly reducing the risk of nicks and cuts. The gap provided between the nearest points on adjacent blades mitigates the historical downside of reduced spans—that of limited space for wash-through between blades.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods, and materials are described below.

Other features and advantages of the invention will be apparent from the following detailed description, and from the claims.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate similar or substantially identical elements, and in which:

FIG. 1 is a perspective view of a razor.

FIG. 2 shows a schematic cross-section through a razor cartridge of the present invention having three blades.

FIG. 3 shows the schematic of FIG. 2 with a razor cartridge having five blades.

FIGS. 4A and 4B show schematically the difference in skin bulge for cartridges with different spans between blades.

FIG. 5 shows a blade of the present invention.

FIG. 6 shows, illustratively, dimensions on a pair of blades according to the present invention.

FIGS. 7A and 7B show schematically the difference in inter-blade gap as the span between blades and angle of the leading blade is varied.

FIG. 8 shows an embodiment of the invention incorporating a support as part of the housing.

### DETAILED DESCRIPTION OF THE INVENTION

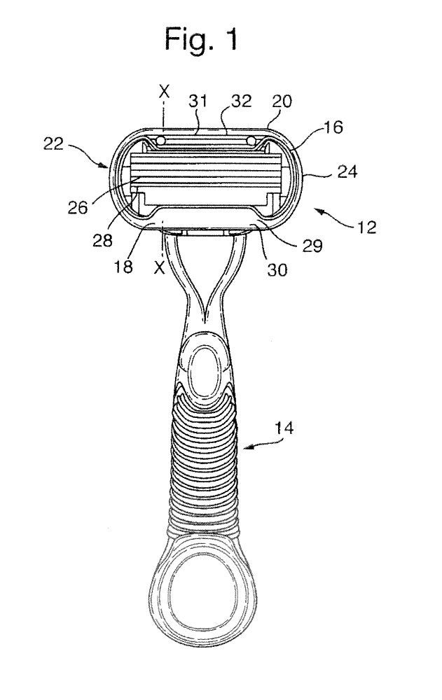

FIG. 1 shows a wet shaving razor 10 formed of a razor cartridge 12 attached to a handle 14. The razor cartridge is formed of a housing 16 having a front 18, a rear 20 and first and second opposing side walls 22, 24 disposed transverse to and between the front wall and rear wall. Two or more blades 26 with sharp cutting edges 28 are mounted within the housing 16 and extend between the first and second opposing side walls 22, 24. In embodiments, the razor cartridge 12 has a first skin contact point 29, typically a guard 30, located ahead of the blades and a second skin contact point 31, typically a cap 32, located behind the blades. In the embodiment shown, the guard is disposed at the front of the housing and the cap is disposed at the rear of the housing. However, it will be appreciated that, in an alternative embodiment, the respective positioning of the guard and cap may be reversed or the guard may be formed separately to the housing and mounted directly to the razor handle.

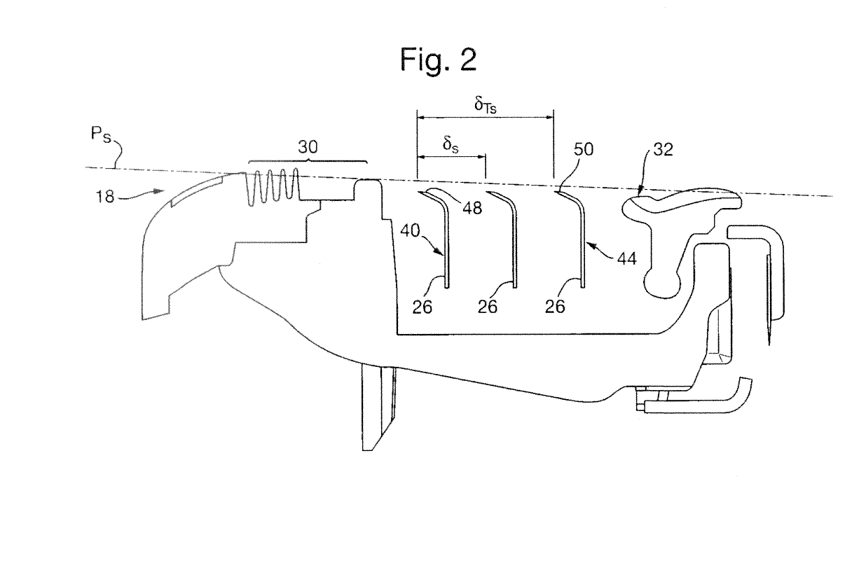

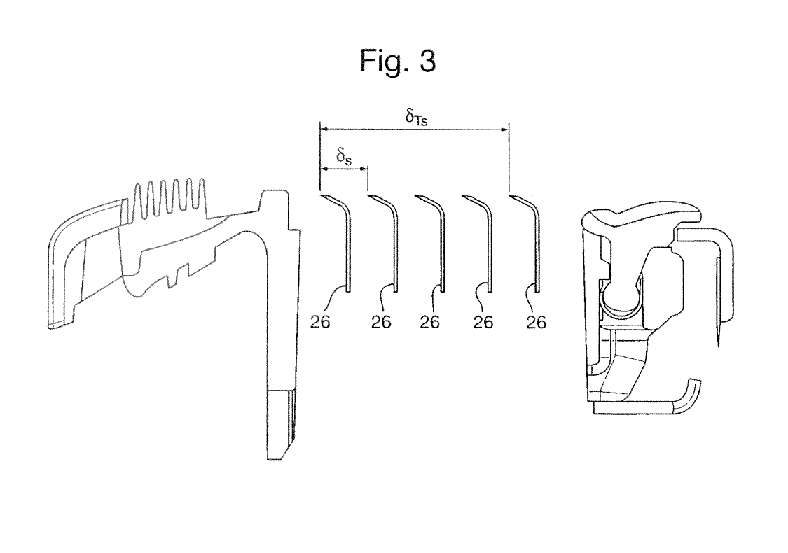

FIG. 2 shows the arrangement of blades in a cartridge having three blades 26. While this figure is shown with three blades, it will be appreciated that the cartridge could have fewer or more blades, for example, as shown in FIG. 3, where the cartridge has five blades. FIG. 2 shows a schematic cross-section through x-x of a cartridge shown in FIG. 1. A primary blade 40 is located adjacent the guard 30 at the front end 18 of the cartridge and a final blade 44 is located adjacent the cap 32 at the rear end 20 of the cartridge, with no other blades positioned between the primary and final blades. Each of the blades has a blade edge (e.g. the primary blade edge 48 and final blade edge 50) that extend in parallel to a length of the cartridge. The blade edges lie in or near a skin contact plane y that is tangential to the first skin contact point and the second skin contact point. The blades 40, 44 extend away from the front end 18 of the cartridge at an angle α beneath the skin contact plane Pₛ.

A span δₛ is defined between each pair of adjacent blade edges, and a total span δₜₛ is defined between the primary blade edge 48 and the final blade edge 50. The span between adjacent blade edges may be the same for each pair of blades in a cartridge, or the span between adjacent blade edges may vary at different points in the cartridge. For example, in a three-blade cartridge having a primary, second and final blade, the span between the primary and second blade edges may be less than, equal to or greater than the span between the second and final blade edges.

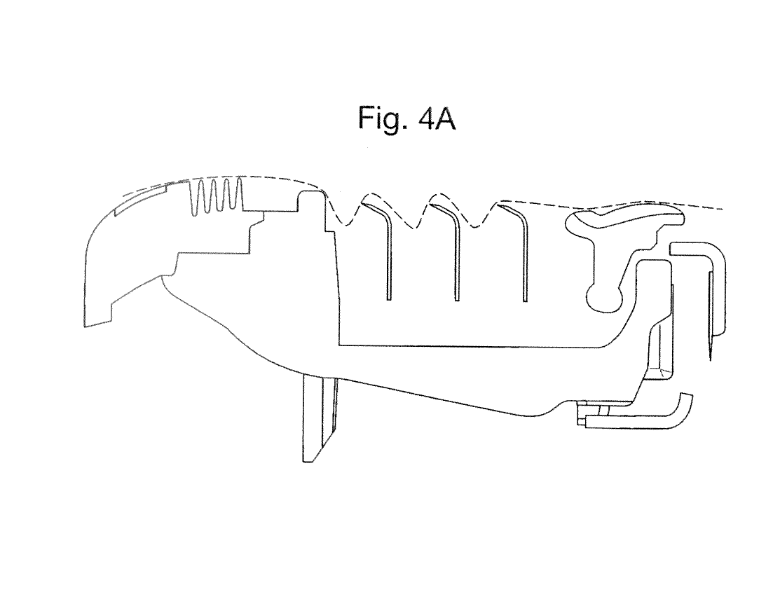

The span δₛ for each pair of adjacent blades is less than 1.0 mm, preferably less than 0.85 mm, more preferably less than 0.75 mm. There are multiple advantages associated with a span δₛ of less than 1.0 mm. Namely:
1) Reducing the span between adjacent blades reduces the overall space required on a cartridge for the blades versus a cartridge incorporating blades with larger inter-blade spans. Thus either the overall footprint of the razor cartridge can be reduced, or additional space on the cartridge is made available for e.g. a larger lubrastrip or guard.
2) In a multi-blade razor cartridge, there is a chance that each blade may cut an individual hair, known as the hysteresis effect. Specifically, during a shaving stroke, blades pull hairs out of the skin while cutting. In the time taken to shave, there is insufficient time for the hair to fully recede into the skin before a subsequent blade engages. Thus, in an ideal system, each of the blades will have the opportunity to cut the same hair. Providing a span of less than 1.0 mm increases the likelihood that adjacent blades will contact the same hair as there is less time for the hair to recede beneath the skin's surface.
3) Providing a span of less than 1.0 mm reduces the amount of skin that can bulge into the gap between adjacent blades. This is shown schematically in FIGS. 4A and 4B, where the span between adjacent blades in FIG. 4A is larger than that of FIG. 4B. It can be seen that less skin bulges between the blades where the span is smaller. This in turn reduces the likelihood of nicks and cuts being caused by contact between the trailing blade and skin.

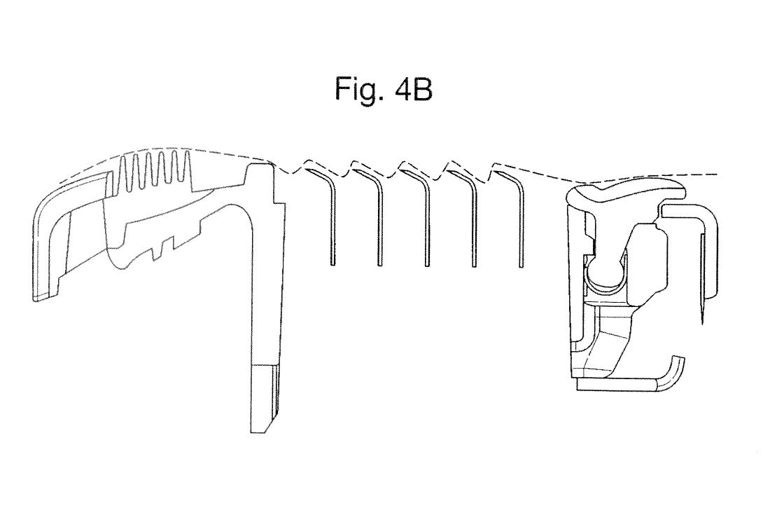

FIG. 5 shows a blade of the present invention, having a cutting portion 30 and a supporting portion 40, extending at an angle θ from the cutting portion. A bent portion 50 connects the cutting portion and the supporting portion, all of which are formed of a single strip of material. The cutting portion has at its free end a blade edge 52. In the embodiment shown in FIG. 5, the blade edge has a tip 54 formed between two facets 54a, 54b extending from front 56, and rear 58 walls of the blade. Alternatively, the blade edge may have a single facet with the tip 54 located at the end of one of the front or back walls of the blade.

To facilitate wash-through between adjacent blades, an inter-blade gap δ_{g} is provided between each adjacent pair of blades. Each pair of blades has a leading blade 70 and a trailing blade 72, with the leading blade located nearer the front of the cartridge and the trailing blade located nearer the rear of the cartridge. The inter-blade gap δ_{g} measures the distance between the two closest points in each pair of blades. Typically, the distance between blades is shortest between the rear wall 58 of the leading blade 70 and the front wall 56 of the trailing blade 72. More typically, the inter-blade gap will be measured between the bent portion 50 of the leading blade 70 and the cutting portion 30 of the trailing blade 72.

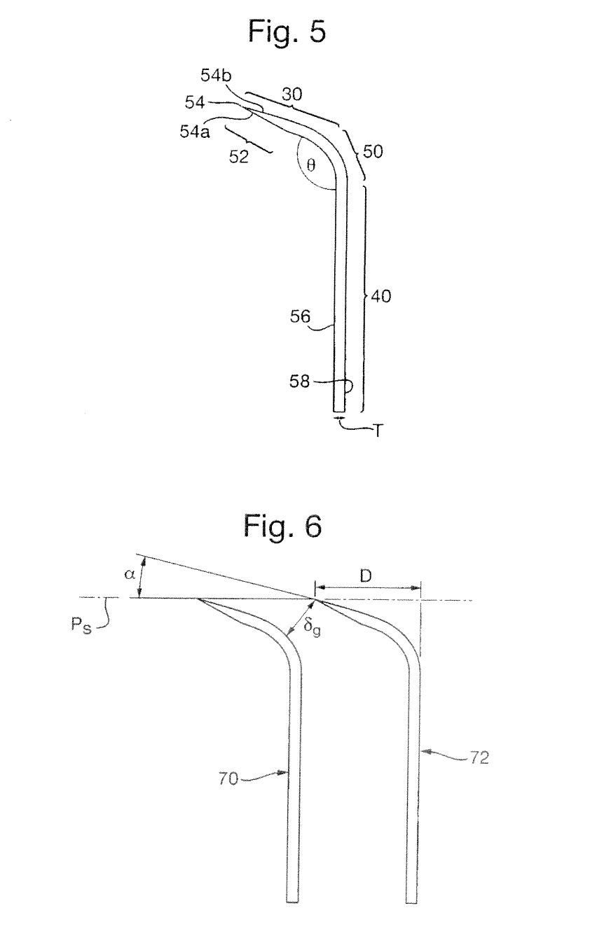

FIG. 6 shows an enlarged and simplified schematic of a pair of blades of the present invention. The main factors that influence the inter-blade gap δ_{g}, include:

a) The angle α of the cutting portion relative to the skin contact plane Pₛ of the leading blade;

b) The distance D from the blade edge to a tangent of the back wall of the supporting portion of the leading blade, measured in a direction perpendicular to the tangent;

The gap may be provided by one or both of a combination of the above. The gap δ_{g} should be at least 0.15 mm. Preferably, the gap δ_{g} is between 0.3 mm, 0.4 mm or 0.5 mm and 0.6 mm, 0.75 mm and 1.0 mm. In embodiments, the span between blade edges in the pair of blades is less than 1.0 mm, thus in preferred embodiments, the distance δ_{g} is less than or equal to the span between blades edges of the same pair of blades.

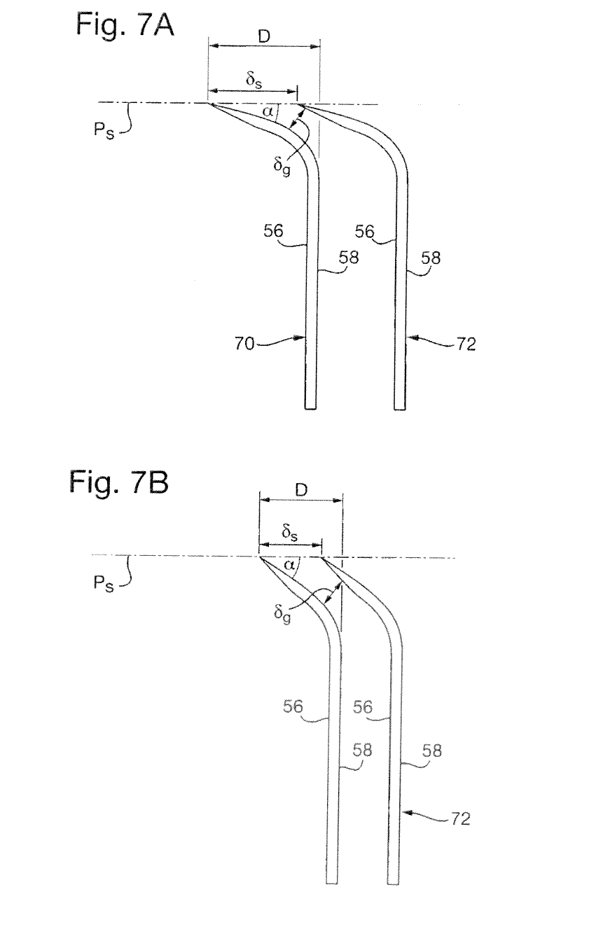

If the distance D is equal to or greater than the span between adjacent blades, as shown schematically in FIGS. 7A and 7B, the inter-blade gap is determined by the angle α between the cutting edge of the leading blade and the skin contact plane Pₛ. Specifically, if the angle α=0°, then the tip of the trailing blade would come into contact with the rear wall of either the blade edge or bent portion of the leading blade. The inter-blade gap δ_{g} is determined by the equation:

δ_{g}=δₛ\sqrt{1−cos²}(α)

According to this definition, to ensure an inter-blade gap δ_{g} of at least 0.15 mm, and for a span of less than 1.0 mm, α should be at least 9°.

The impact that the angle has is shown illustratively in FIG. 7A and 7B, where for a span of 0.7 mm, an angle α of 18° is required to provide the same inter-blade gap δ_{g} as for a span of 0.4 mm and an angle α of 40°. Thus, it can be seen that as the span is reduced, and where the distance D is greater than the span, to increase the gap δ_{g} it is necessary to additionally increase the angle between the cutting edge and the skin contact plane Pₛ.

In preferred embodiments, the distance D is less than the span.

Where D is less than the span, then the gap is provided by a combination of the distance above, based on the angle of the leading blade, the span, and the difference between the span and distance D. Specifically, where D is 0.15 mm or more less than the span, then this distance D alone provides sufficient space for wash-through of hair and other shaving debris.

The distance D is, at least in part, determined by the length of the cutting portion, the radius of curvature between the cutting portion and the supporting portion and the angle between the two. To ensure a suitable and strong cutting surface, the cutting portion has a length of at least 0.15 mm. If the cutting portion is too small, there is likely to be insufficient space to form an appropriate blade edge. As the angle between the supporting portion and the cutting portion is decreased, the distance D is reduced. In preferred embodiments, the supporting portion of the blade is held in position vertically within the housing. In such embodiments, the angle between the supporting portion and the cutting portion is determined by the required blade plane angle.

The radius of curvature is between 0.20 mm and 0.60 mm, preferably 0.25 mm and 0.45 mm. The radius of curvature influences the strength of blade structure, for example, reducing the radius of curvature provides for a sturdier overall blade structure and reduces the overall area of the curved portion. Specifically, having a smaller radius of curvature permits a more preferable ratio of length of cutting portion to distance D.

The blade has a thickness T of between 0.05 mm and 0.15 mm, preferably 0.05 mm and 0.10 mm, measured between the front and back walls of the blade. This provides a blade thick enough to withstand typical forces experienced during shaving by minimizing the overall space occupied by the blade. In this respect, reducing the thickness of the blade allows additional space between corresponding points on adjacent blades through which shaving hair and debris may be washed.

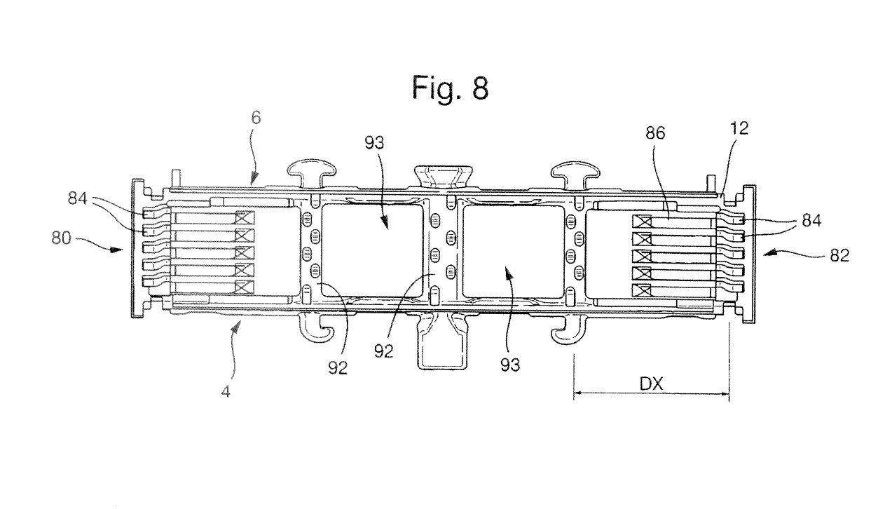

Blades of a thickness described above are more prone to flexing under typical shaving forces compared with more traditional blades welded to thicker blade supports. Accordingly, as shown in FIG. 8, at least two blade support members 92 are provided, extending from either the front or rear of the housing. It will be appreciated that although three blade support members 92 are shown, there may be two, four or more blade support members 92 provided in the cartridge. The blade support members 92 are spaced apart from one another, preferably at regular intervals across the width of the cartridge, to provide even support and regular touch points for the respective blades. By spacing the blade support members 92 apart from one another, gaps 93 are still provided between them through which water can flow when the cartridge is rinsed.

The guard is typically a unitary molded member that can be formed of a rigid plastic at the bottom and an elastomeric material at the top. The elastomeric material is chosen to provide flexibility for ribs, e.g. as is described in detail in U.S. Pat. No. 5,249,361. The tips of ribs are typically in a plane that is about half-way between a plane that passes through the cutting edges of the blades and the top of clips provided at the ends of the blades. The raised tips (relative to the cutting edges) may provide effective shielding of the blades and may also exert a traction force on the skin to stretch it and raise hairs before the primary blade, thus reducing overall cutting force.

During shaving, the blades may be independently resiliently movable with respect to housing 12. The housing may pivot with respect to the handle with the result that the cutting edges will follow the contours of the skin surface. It may be advantageous to set the blades to have different exposures relative to the skin contact plane as described in U.S. Pat. No. 6,212,777. The exposure is determined by the distance of the blade tip from the skin contact plane. Additionally, different blade spans can be set between groups of two adjacent elements that contact the skin, e.g. as also described in detail in U.S. Pat. No. 6,212,777.

According to some embodiments of the invention, a razor is provided, which generally comprises a razor cartridge according to the invention as described hereinabove, and a handle (or grip portion) permanently or removably attached to the cartridge. The razor can be manual or power driven and can be used for wet and/or dry application. The razor cartridge may be replaceable and/or pivotally connected to the handle (e.g. via a cartridge connecting structure) and in turn or independently permanently fixed to a handle (e.g. a disposable razor). In some embodiments, the cartridge connecting structure includes at least one arm to releasably engage the razor cartridge.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, and any patent application or patent to which this application claims priority or benefit thereof is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor cartridge comprising:
a. a housing having a front and a rear;
b. at least two blades including a leading blade and a trailing blade, each having a cutting edge directed towards a front of the housing, the cutting edge of the leading blade being positioned between the cutting edge of the trailing blade and the front of the housing;
c. a span δₛ of less than 1.0 mm between the cutting edges of the trailing and leading blades;
d. an inter-blade gap δ_{g} between the leading and trailing blades, measured at the shortest distance between the leading and trailing blades, wherein the gap δ_{g} is less than or equal to the span and greater than 0.15 mm.

2. The razor cartridge of claim 1, wherein the leading blade comprises a straight cutting portion, a straight supporting portion positioned at an angle θ relative to the cutting portion, and a bent portion connecting the cutting portion and the supporting portion, wherein the cutting portion, the supporting portion and the curved portion are formed of a single piece of material.

3. The razor cartridge of claim 2, wherein the supporting portion of the leading blade extends at an angle θ of between 100° and 130° from the cutting portion and the bent portion has a radius of curvature of between 0.20 mm and 0.6 mm.

4. The razor cartridge of claim 1, comprising a skin contact plane tangential to a first contact point at a front of the cartridge and a second contact point towards the rear of the cartridge, wherein the cutting edge of the leading blade is positioned at an angle α of at least 9°.

5. The razor cartridge of claim 1, each blade having a distance D between the cutting edge and a tangent of the back surface of a blade, measured in a direction perpendicular to the tangent, wherein the distance D of the leading blade is less than or equal to the span.

6. The razor cartridge of claim 1, each blade having a thickness T from a front surface to a back surface to the blade, wherein the thickness T of the leading blade is less than 0.15 mm.

7. The razor cartridge of claim 1, wherein the inter-blade gap δ_{g} is measured between the bent portion of the leading blade and the cutting portion of the trailing blade.

8. The razor cartridge of claim 1, wherein the angle α of the cutting edge of the leading blade relative to the skin contact plane Pₛ is greater than the angle α of the cutting edge of the trailing blade relative to the skin contact plane Pₛ.
